(19) United States
(12) Patent Application Publication
(10) Pub. No.: US 2012/0025494 A1
(43) Pub. Date: Feb. 2, 2012

(54) Hip-Borne Towed Child Carrier for Jogging and Hiking

(76) Inventor: Douglas Cameron Griffith, La Canada Flintridge, CA (US)

(21) Appl. No.: 13/194,277

(22) Filed: Jul. 29, 2011

Related U.S. Application Data
(60) Provisional application No. 61/368,991, filed on Jul. 29, 2010.

(51) Int. Cl. B62B 3/02

(52) U.S. Cl. 280/647

(57) ABSTRACT

A two-wheeled towed child carrier that attaches to the user's hips and trails behind as the user jogs or hikes. It employs a moderately flexible tube frame with rotating and elastic connections that significantly isolate the carrier from the up-down, fore-aft motion of the user's hips, and further isolate the child from any residual motion of the rest of the carrier, ensuring a calm ride for the child and minimizing feedback to the user even during aggressive or long-distance jogging. The child is carried in a gondola that swings in a pendulum manner from supports extending upward from the axle, and the weight of the carrier is balanced about the axle, the result being that the total weight of the child and carrier is borne by the axle and no perceptible weight is borne by the user.

### CROSS-REFERENCE TO RELATED APPLICATIONS

Application No. 61/368,991 (Provisional)

A portion of the disclosure of this patent document contains material which is subject to copyright protection. The copyright owner has no objection to the facsimile reproduction by anyone of the patent document or disclosure, as it appears in the Patent and Trademark Office patent file or records, but otherwise reserves all copyright rights whatsoever.

### STATEMENT REGARDING FEDERALLY SPONSORED RESEARCH OR DEVELOPMENT

Not Applicable.

### REFERENCE TO COMPACT DISC APPENDIX

Not Applicable.

### BACKGROUND OF THE INVENTION

1.Field of Endeavor

The invention pertains to the field of child carriers suitable for jogging, which includes jogging strollers and towed child carriers. The invention falls within the latter category. It is a two-wheeled apparatus that contains a small child, attaches to the user's hips, and trails behind the user as he or she jogs or hikes.

2. Related Information/Prior Art

Currently there are only two known types of apparatuses that enable a user to jog while carrying a small child: jogging strollers, and towed child carriers. Either such devise will also permit hiking with the child, and the carriage of cargo. Jogging strollers, currently in wide commercial use, are basically enlarged-wheel strollers (typically with three wheels arranged in a tricycle configuration) designed to be pushed and steered by the user's hands as he or she runs. The problems with jogging strollers are four-fold and apply to both the jogging and hiking applications, although the problems are amplified in the case of jogging: 1) because the stroller must be pushed and steered by the user's hands, the user is deprived of the ability to swing his or her arms in a natural gate, thereby diminishing comfort, enjoyment, and performance; 2) steering is awkward in that it requires the user to push downward on the handle bar so as to lift the front wheel(s) from the ground, move the handle bar laterally to displace the front wheel(s) in the intended direction, and then release the downward force to let the front wheel(s) regain contact with the ground; 3) because of the relative height differential between the handle bar and the user, there is a downward component to the user's pushing force, making it cumbersome to negotiate curbs and off-road obstacles such as rocks; and 4) because of the necessary proximity between the user and the stroller, the user's forward stride is limited by the risk of contact between the ball of the foot and the rear wheel(s), which, during jogging, can cause the user to fall and the stroller to flip over. Towed child carrier concepts, such as that disclosed herein, are exemplified in U.S. Pat. Nos. 5,062,651 entitled “Jogging Baby Carriage;” 5,265,891 entitled “Jogger's Baby Carriage Apparatus;” and 7,938,409 entitled “Carriage and Incorporated Harness with Damping Mechanisms for Improved Towing and Stability of the Carriage.” The foregoing prior art addresses the cited deficiencies in jogging strollers, but does not adequately address the new challenges that are presented when a carrier is to be towed rather than pushed, including primarily the need to isolate the user's natural cyclic movements while jogging from the carrier and the child in an effective manner so that the user can jog free of feedback from the carrier and the child can enjoy a calm ride free of jarring and bouncing. An additional challenge presented by the towed carrier concept relative to the jogging stroller concept, and which is inadequately addressed by the prior art, is the avoidance of vertical loading being placed on the user as the child leans forward or backward, which can reduce jogging enjoyment and performance. An additional challenge presented by the towed carrier concept relative to the jogging stroller concept, and which is inadequately addressed by the prior art, is that the user is not manually holding onto the carrier and therefore needs assurance that there will be no inadvertent separation of the carrier from the user, or rolling over of the carrier, or failure of the carrier to smoothly follow the user's path.

### BRIEF SUMMARY OF THE INVENTION

Object of the Invention.

To enable a person to comfortably, safely and effectively jog with a small child by towing the child from the person's hips in a carrier that isolates the user's natural movements from the carrier and the child, and vice-versa.

Improvements over Prior Art.

The invention solves the problems of jogging strollers by attaching to the user's hips and trailing behind the user as he or she runs. The user's hands and arms are free to swing in a natural motion, thereby enhancing comfort and performance. Additionally, the hands are available for things like taking a drink of water from a water bottle, or adjusting one's gear or clothing. There is no steering challenge because the apparatus simply follows the user. And because the pulling force from the user's hips always has a slight upward component instead of the downward component that exists when pushing a stroller, the load travels more easily up and over obstacles. Finally, the portion of the apparatus that attaches to the jogger's hips arches upward before coming back down to attach to the axle, well aft of the user so as to reduce the possibility of interference with the user's stride. The towed child carrier concept presents at least three new challenges relative to jogging strollers: 1) the tendency for the cyclic motions of the user due to his or her gait to be undesirably and unsafely imparted to the carrier and child, and for uncomfortable and distracting mechanical feedback to the user; 2) the potential for some amount of vertical weight from the carrier and the child to be placed on the user, decreasing jogging comfort and performance; and 3) the potential for inadvertent rollovers, separation, and imprecise tracking by virtue of the fact that the user has no hands on the carrier. As an improvement upon the prior art for towed child carriers, the invention puts itself on par with jogging strollers with respect to the foregoing challenges by: 1) using various elastic and rotational features that isolate the up-and-down and fore-aft pumping motion of the user's hips from the child, ensuring a calm ride for the child and minimizing feedback to the user; 2) using a gondola system for containing the child, whereby the child swings freely in a pendulum manner from support members that are borne directly by the axle, and ensuring that the overall structure is balanced about the axle, the result being the absence of any perceptible vertical weight upon the user; and 3) featuring a two-point system of attaching the carrier to the user (one attachment point at each hip) so that the user's body counteracts rollover forces, there is no single-point failure that will cause a separation of the carrier from the user, and the carrier will more accurately track the user's path across the ground.

### BRIEF DESCRIPTION OF THE SEVERAL VIEWS OF THE DRAWING

FIG. 1 depicts the invention from an aft quarter aspect.

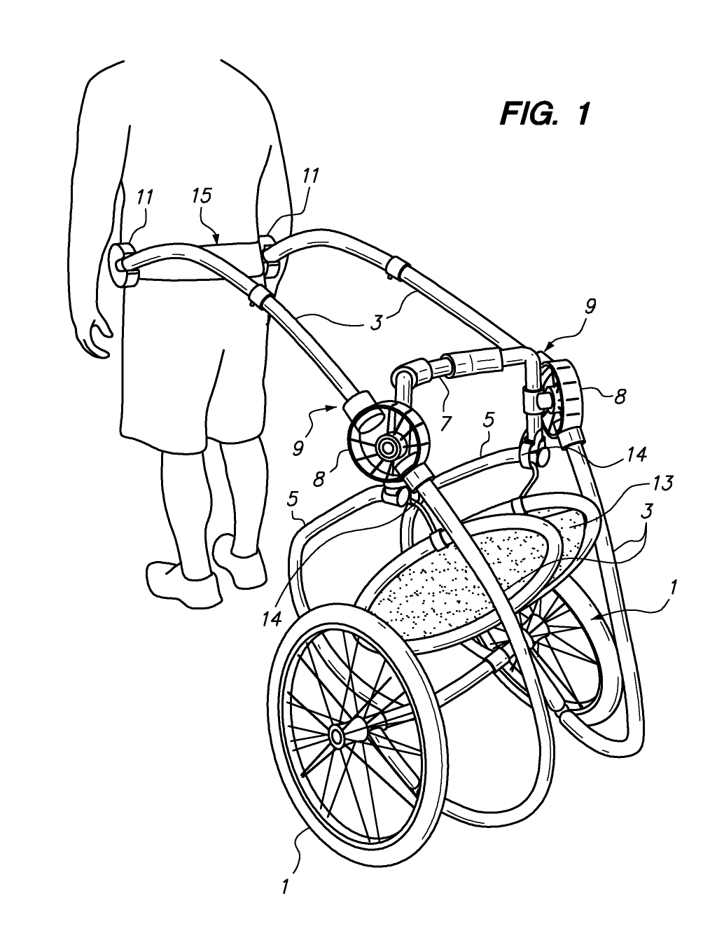

FIG. 2 depicts the invention from a forward quarter aspect.

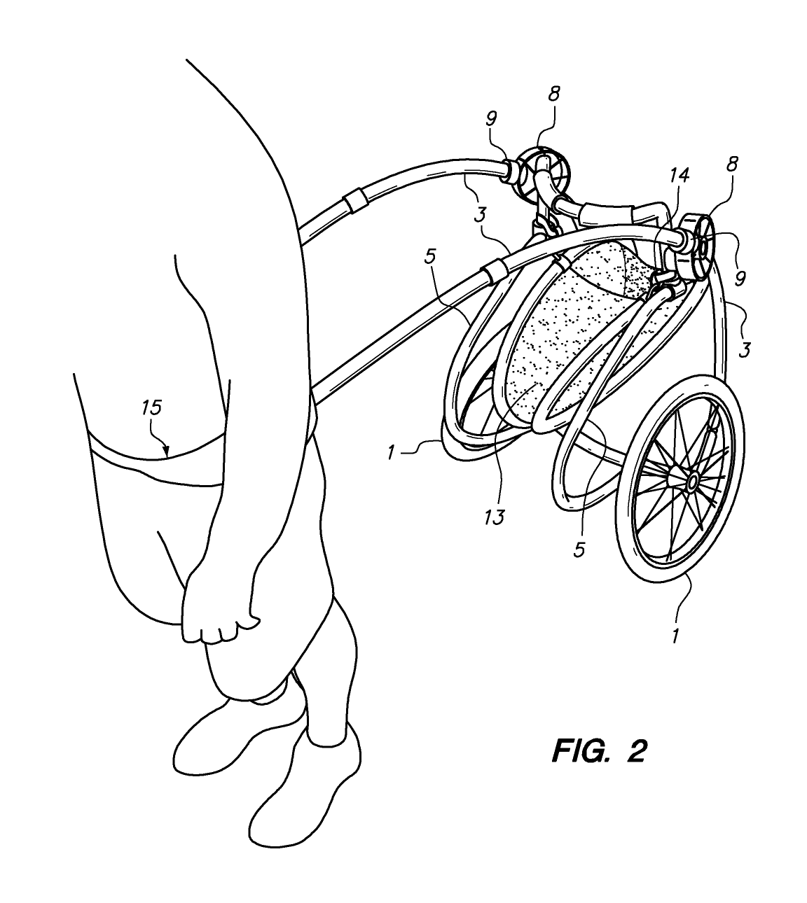

FIG. 3 depicts the invention from a direct rear aspect.

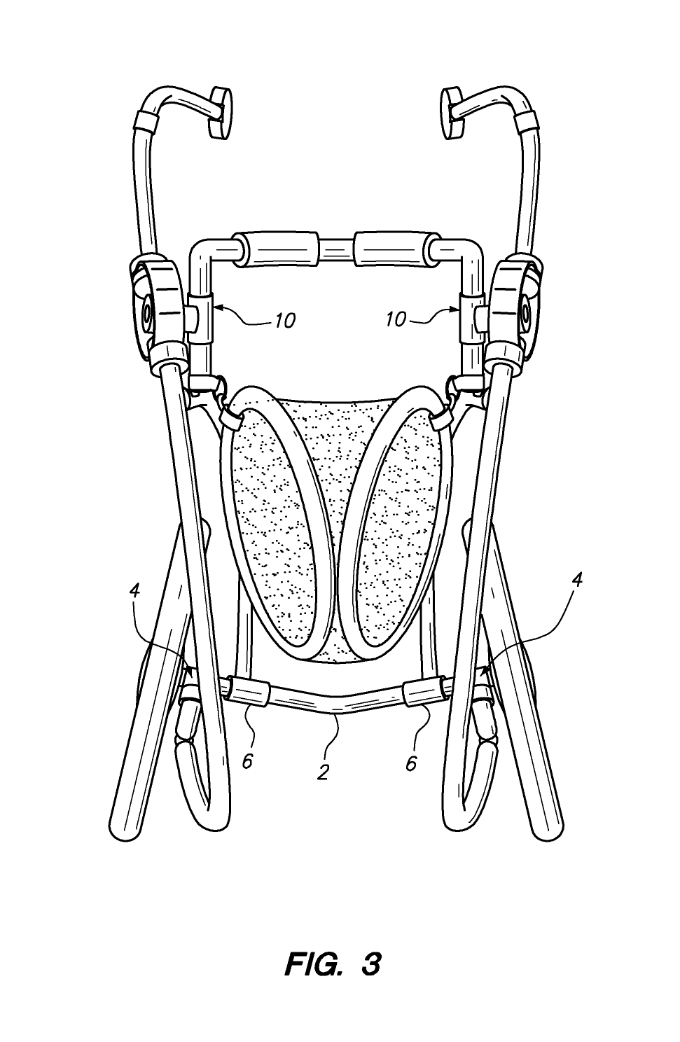

FIG. 4 depicts the invention in the standing child configuration from a forward quarter aspect.

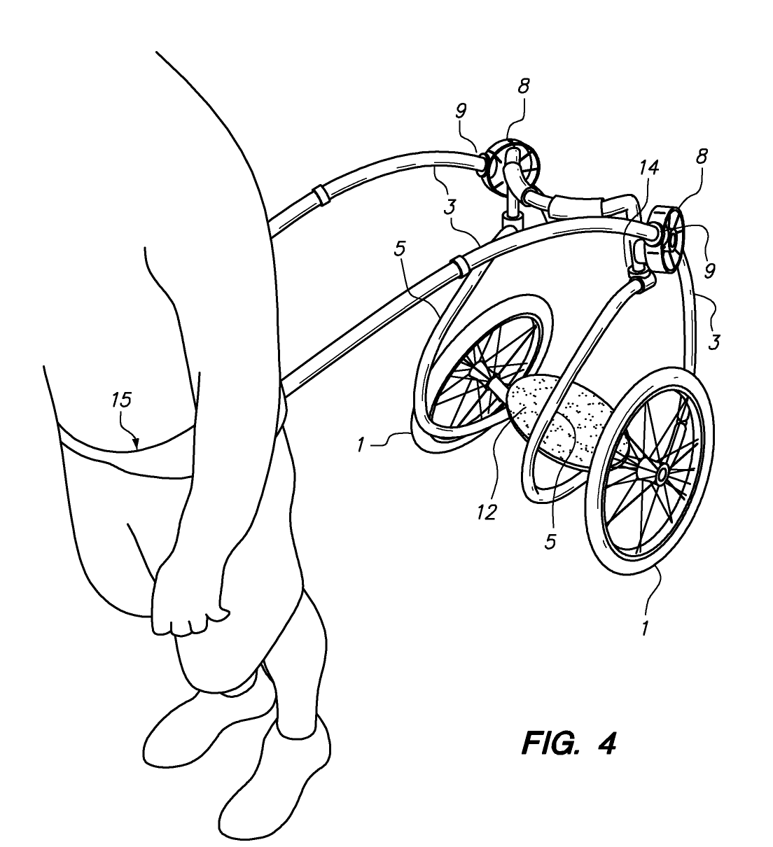

### DETAILED DESCRIPTION OF THE INVENTION

Explanation of the Invention.

The invention is comprised of three systems: 1) the frame—a collapsible, moderately flexible structure consisting of a two-wheeled wheel 1 and axle 2 assembly (“wheel and axle assembly”); two curved tubes (the “thrust tubes”) 3 arching rearward and upward from the user's hips, then downward, and finally forward and upward so as to attach to the bottom-rear quadrant of the axle by means of rod ends 4; two curved tubes 5 connected to the axle with rod ends 6 and extending upward from the axle (the “vertical load support tubes”), together with a curved cross-member 7 that keeps the tops of the vertical load support tubes equidistant from one another; a rear elastic housing 8 and rotating bearing 9 on each thrust tube that enables the thrust tube to restrain the top end of the associated vertical load support tube from flopping fore or aft, while at the same time isolating the cyclic movement of the thrust tube imparted by the user's gait from the associated vertical load support tube; collars 10 that insert into the center of each elastic housing on the thrust tubes and slides up and down on the associated vertical load support tube to accommodate varying user heights; a forward elastic housing 11 at the front end of each thrust tube that restrains the end of the tube while at the same time isolating cyclic movement of the housing from the thrust tube; and a flat platform 12 for standing, affixed rigidly atop the axle; 2) the gondola 13—a collapsible, detachable child compartment made of tubing and fabric, hung by suspension straps 14 from the vertical load support tubes in such a way that it imparts no vertical weight upon the user and is free to swing gently in order to dissipate any residual (non-isolated) motion imparted by the thrust tubes; and 3) the hip harness 15—a fabric belt that permits the user to attach the thrust tubes to the hips, incorporating an elastically connected pouch at each hip to receive the associated forward elastic housing so as to partially isolate the hips' motion from the thrust tubes and also permit limited twisting/rotation of the hips within the frame. The user can detach the thrust tubes from the hip harness and continue to wear the hip harness while separated from the rest of the invention, or remove the hip harness from his or her person and leave it attached to the rest of the invention.

Process of Making the Invention.

1) The frame. The frame is made by cutting and bending tubes of aluminum so as to form the thrust tubes, and attaching them to the axle by means of rod ends that permit the thrust tubes to rotate freely about the axle during normal operation, and also twist within the rod ends for collapsibility. Each thrust tube features a rear elastic housing, situated above and roughly vertically in line with the associated end of the axle, into which the top of the associated vertical load support tube is inserted by means of a collar that slides up and down the upper portion of the vertical load support tube. The housing permits the vertical load support tube to move fore and aft a limited amount (approx. 2 inches fore, 2 inches aft) within the housing as accelerations are imparted, but elastically forces it back to the neutral/center position. It also permits the thrust tubes to move up and down a limited amount (approx. 2 inches up, 2 inches down) without imparting more than modest motion to the vertical load support tubes. Additionally, the forward segments of the thrust tubes attach to the housing using a rotational bearing, freeing those segments to twist within the connection to the housing. The aft segments of the thrust tubes, at a location approximately 4-6 inches from the axle, each incorporate a swivel coupling that permits the thrust tube to swivel inward and outward so as to make the front of the apparatus adjustable to varying user girths. The thrust tubes are segmented so as to be collapsible for convenient storage and carrying. Attached to the front end of each thrust tube is a forward elastic housing into which the tube inserts. These housings are similar to the rear elastic housings but are smaller and relatively flush with the user's hips when fastened to the user via the hip harness. They elastically permit limited fore-aft travel of the ends of the thrust tubes within them (approximately 1.5 inches in each direction) but bring the thrust tubes to the neutral position when there is no acceleration. They also permit the housing to move up and down a limited amount with the user's gait (approximately 1.5 inches in each direction) in relative isolation from the thrust tubes. The vertical load support tubes are made by cutting and bending aluminum tubing so that they attach to the axle by way of rod ends, permitting them to rotate about the axle for normal movement and collapsibility. They arch forward as they extend upward. Each has a slightly curved, near-vertical segment 4-5 inches long near the top portion, which accommodates a sliding collar that can be moved up and down along the segment and locked into the desired position, which collar has a horizontal protrusion that inserts into the center of the rear elastic housing on the associated thrust tube at whatever height that housing is, based on the user's height. Spanning the tops of the vertical load support tubes is a curved cross-member to keep them from bending or failing inward or outward, which doubles as a handlebar for the invention's standing child configuration. They also have attachment points for suspending the gondola. The axle is made of curved aluminum tubing, with the lowest portion in the center in order to create clearance for the swinging gondola. The wheels are basic bicycle-type wheels with a diameter of approximately 20 inches, canted outward at the bottom to both create a wider wheel base for stability and reduce the likelihood that a wheel's impact with a stationary obstacle will damage the apparatus or injure the child. 2) The gondola. The gondola is made by cutting, bending, and assembling aluminum tubing into a child containment compartment, affixing a fabric seat with safety restraints, and enclosing it with a fabric shell with adjustable degrees of openness. It is sufficiently wide to accommodate an average-sized 2-3 year-old child, but sufficiently narrow to swing freely 3-4 inches each fore and aft without contacting the vertical load support tubes to the front or thrust tubes to the rear. It hangs from the vertical load support tubes, is collapsible, and is easily detachable for convenient storage, carrying, and conversion into the standing child or cargo configurations. 3) The hip harness. The hip harness is a wide elastic belt that stretches firmly around the user's waist and has a pouch on each side for accommodating the forward elastic housings of the thrust tubes. The pouches are elastically attached to the sides of the hip harness to permit a limited amount of user hip rotation when attached to the frame.

Using the Invention.

The invention is used by placing the child in the gondola, attaching the gondola to the frame (if not already attached), attaching the frame to the hip harness (if not already attached), fastening the hip harness around the user's waist, and beginning to jog or hike. An alternate use is carrying cargo, accomplished by replacing the child gondola with one designed for cargo. Another alternate use is carrying a larger child, accomplished by removing the gondola and having the child stand on the platform that is affixed to the axle and hold onto the curved cross-member that adjoins the vertical load support tubes.

1. An apparatus for towing a child by the user's hips while jogging or hiking, comprised of two curved, collapsible, moderately flexible fore-aft tubes arching from each hip rearward to attach to a two-wheeled axle from behind and below; curved, collapsible, moderately flexible vertical load support tubes extending upward from the axle and restrained at their tops by the fore-aft tubes utilizing an elastic and rotating system that isolates the movement of the fore-aft tubes from the vertical load support tubes and vice-versa; a wheel and axle assembly; a detachable tube and fabric gondola for containing the child, suspended by and free to swing from the tops of the vertical load support tubes; and a fabric hip harness that allows the frame to attach to the hips in an elastic fashion so as to isolate the movements of the user's hips from the fore-aft tubes.

2. An apparatus according to claim 1, but with a detachable tube and fabric gondola suitable for carrying cargo instead of a child.

3. An apparatus according to claim 1, but with a flat platform affixed rigidly atop the axle for a large child to stand on while holding onto the curved cross-member that adjoins the vertical load support tubes.
